(19) United States
(12) Patent Application Publication
(10) Pub. No.: US 2018/0100683 A1
(43) Pub. Date: Apr. 12, 2018

(54) FREEZER BLAST CELL FABRIC ROLL UP DOOR

(71) Applicant: Steel Works and Supply, Inc., Angier, NC (US)

(72) Inventors: Jeffrey Dale Hickman, II, Fuquay-Varina, NC (US); Daniel Edward Hickman, Farmville, NC (US)

(21) Appl. No.: 15/834,543

(22) Filed: Dec. 7, 2017

Related U.S. Application Data
(63) Continuation of application No. 15/001,580, filed on Jan. 20, 2016, now abandoned.
(60) Provisional application No. 62/105,823, filed on Jan. 21, 2015.

(51) Int. Cl. F25D 23/02; F25D 13/00; E06B 9/13; E06B 9/58; E06B 9/17; E06B 9/80

(52) U.S. Cl. CPC F25D 23/02; F25D 23/028; F25D 13/00; E06B 2009/805; E06B 9/581; E06B 9/17046; E06B 9/13

(57) ABSTRACT

A freezer blast cell fabric roll up door is disclosed, wherein the freezer blast cell fabric roll up door is built to reliably withstand the high velocity wind loads and harsh freezing environments of a blast freezer. In one example, the presently disclosed freezer blast door comprises a drive or main assembly that further comprises a head plate bracket assembly, a brush bar assembly, a barrel assembly, a guide assembly, and a curtain assembly.

### CROSS-REFERENCE TO RELATED APPLICATIONS

This application is a continuation application of U.S. Utility patent application Ser. No. 15/001,580, filed Jan. 20, 2016, which claims the benefit of U.S. Provisional Application No. 62/105,823, filed Jan. 21, 2015, the entire contents of which are incorporated by reference herein in their entireties.

### TECHNICAL FIELD

The presently disclosed subject matter relates generally to blast freezers, and more particularly to a freezer blast cell fabric roll up door.

### BACKGROUND

A blast freezer is designed to rapidly ramp down the temperature of foods and goods, freezing them extremely quickly. Blast freezers operate with blowers forcing chilled air over product to rapidly cool them down. Blast freezers in the meat/processing industry are typically very large, capable of holding multiple pallets, (several thousand pounds of product), per freeze cycle. Blast freezers use a lot of energy and high volume circulating air. However, in current blast freezers there can be reliability issues with respect to the components thereof being able to withstand high velocity wind loads and the harsh freezing environments.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a perspective view of an example of the presently disclosed freezer blast cell fabric roll up door;

FIG. 2 through FIG. 6 show various views of a drive or main assembly of the presently disclosed freezer blast cell fabric roll up door;

FIG. 7 through FIG. 12 show various views of a head plate bracket assembly of the presently disclosed freezer blast cell fabric roll up door;

FIG. 13 through FIG. 18 show various views of a brush bar assembly of the presently disclosed freezer blast cell fabric roll up door;

FIG. 19 through FIG. 26 show various views of a barrel assembly of the presently disclosed freezer blast cell fabric roll up door;

FIG. 27 through FIG. 32 show various views of a guide assembly of the presently disclosed freezer blast cell fabric roll up door;

FIG. 33 shows a perspective view of one corner of the lower portion of the frame of the drive assembly;

FIG. 34 shows side and front views of the guide assembly, bottom bar assembly, and horizontal pockets of the presently disclosed freezer blast cell fabric roll up door; and

FIG. 35 shows detailed views of portions of the side view of FIG. 34, particularly in Detail A the guide assembly, bottom bar assembly, and half-round catch block, and in Detail B the horizontal pockets of the presently disclosed freezer blast cell fabric roll up door.

### SUMMARY

The presently disclosed subject matter provides a freezer blast cell fabric roll up door assembly comprising a drive assembly, a head plate bracket assembly, a brush bar assembly, a barrel assembly, a guide assembly; and a curtain assembly, wherein the guide assembly further comprises: a) a formed edge that interlocks with wind locks on the curtain assembly when wind loads exceed a certain threshold; and b) a hold down feature disposed at a bottom portion of the guide assembly that receives a bottom bar assembly disposed at a lower end of the curtain assembly, thereby preventing the door from rising off the ground when wind loads are applied.

In certain aspects. the brush bar assembly comprises one or more brushes coupled to a bar, wherein the one or more brushes have a length substantially equal to the width of the curtain assembly, and further wherein when the door is opened or closed at a certain speed, the brush bar assembly rotates at a speed greater than the speed of the moving door, thereby brushing excess frost off the door as it opens or closes.

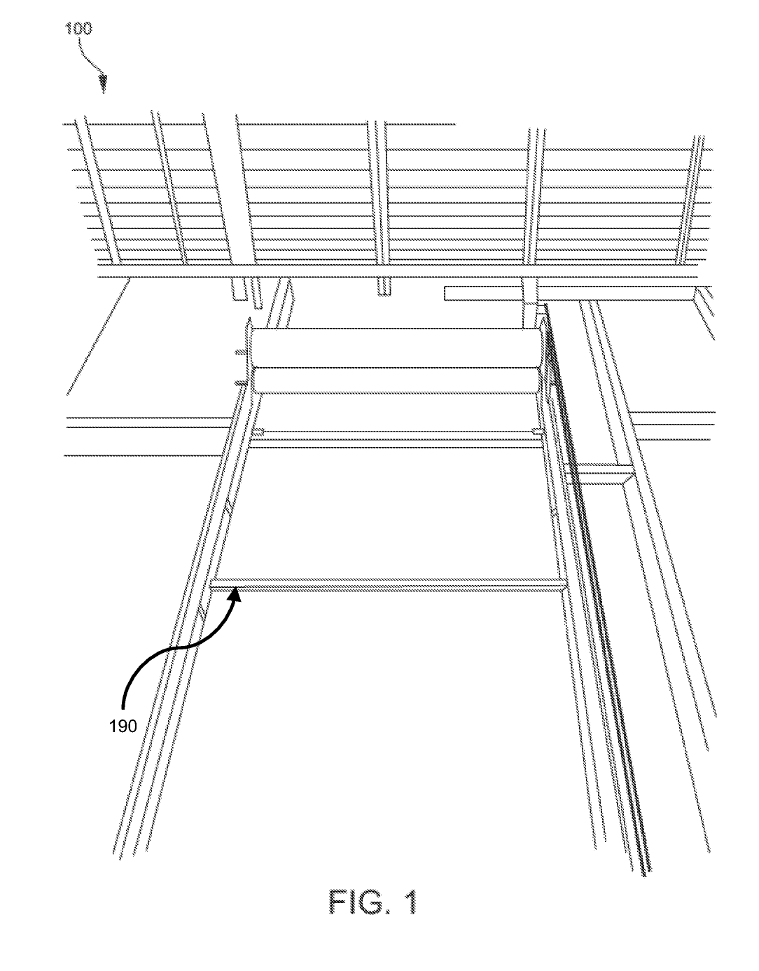

In additional aspects, the curtain assembly further comprises horizontal pockets 190, particularly wherein the curtain assembly further comprises stiffener bars in the horizontal pockets 190 (see FIGS. 1, 34 and 35).

In other aspects, the barrel assembly further comprises a torsion spring coupled to the curtain assembly such that the torsion spring counter balances the curtain assembly, making the curtain assembly easier to raise and lower.

In a further aspect, the hold down feature comprises: a) a lower portion of the guide assembly abuts a base plate at an angle substantially equal to 90 degrees; b) a first guide rail and a second guide rail are arranged on edge along the length of the base plate; c) two or more half-round catch blocks are provided on the face of the first guide rail and/or the second guide rail; and d) two or more wear tabs are provided on the face of the guide assembly, wherein the two or more wear tabs abut the base plate; wherein the bottom bar assembly disposed at the lower end of the curtain falls in under the two or more half-round catch blocks when the curtain is lowered, and wherein a wind load causes the bottom bar assembly to go under the half-round catch blocks to lock the curtain in a down position.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a freezer blast cell fabric roll up door, wherein the freezer blast cell fabric roll up door is built to reliably withstand the high velocity wind loads and harsh freezing environments of a blast freezer. In one example, the presently disclosed freezer blast door comprises a drive or main assembly that further comprises (1) a head plate bracket assembly, (2) a brush bar assembly, (3) a barrel assembly, (4) a guide assembly, and (5) a curtain assembly.

Referring now to FIG. 1 a perspective view of an example of the presently disclosed freezer blast cell fabric roll up door 100 is shown that comprises a drive or main assembly that further comprises (1) a head plate bracket assembly, (2) a brush bar assembly, (3) a barrel assembly, (4) a guide assembly, and (5) a curtain assembly.

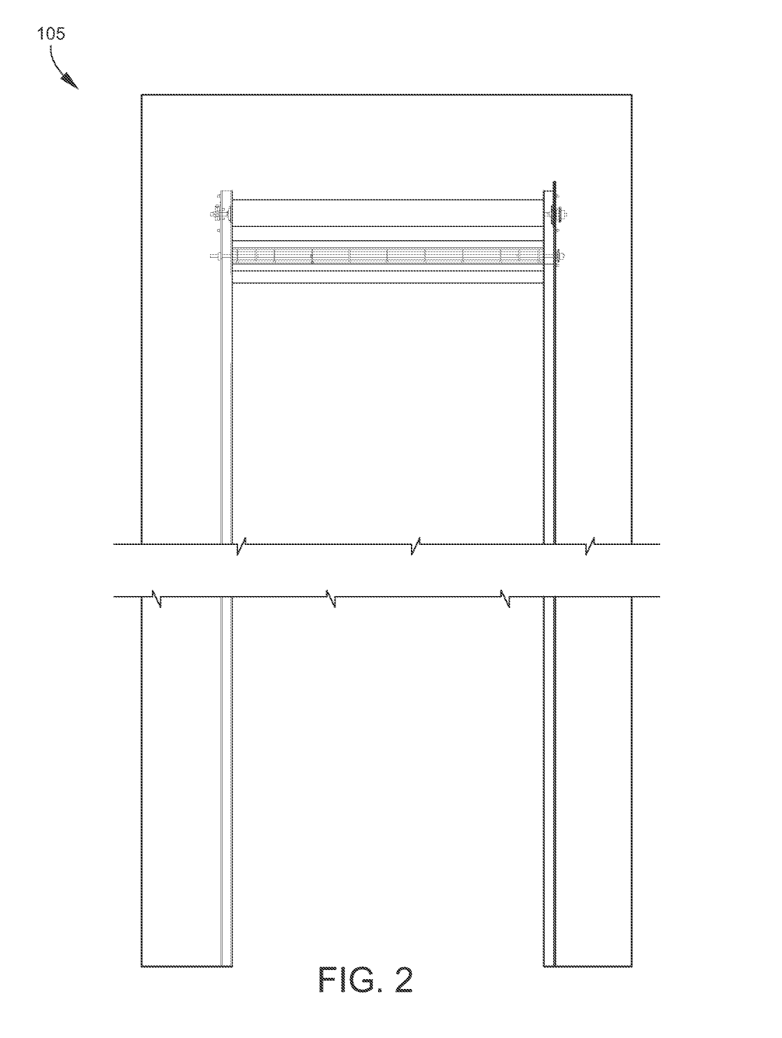

Referring now to FIG. 2 through FIG. 6, various views of a drive or main assembly 105 of the presently disclosed freezer blast cell fabric roll up door are shown. The drive assembly 105 can include any components commonly used in the industry for opening and closing overhead roll up doors, such as, for example, a chain-hoist, motor operators, counter weight, and the like.

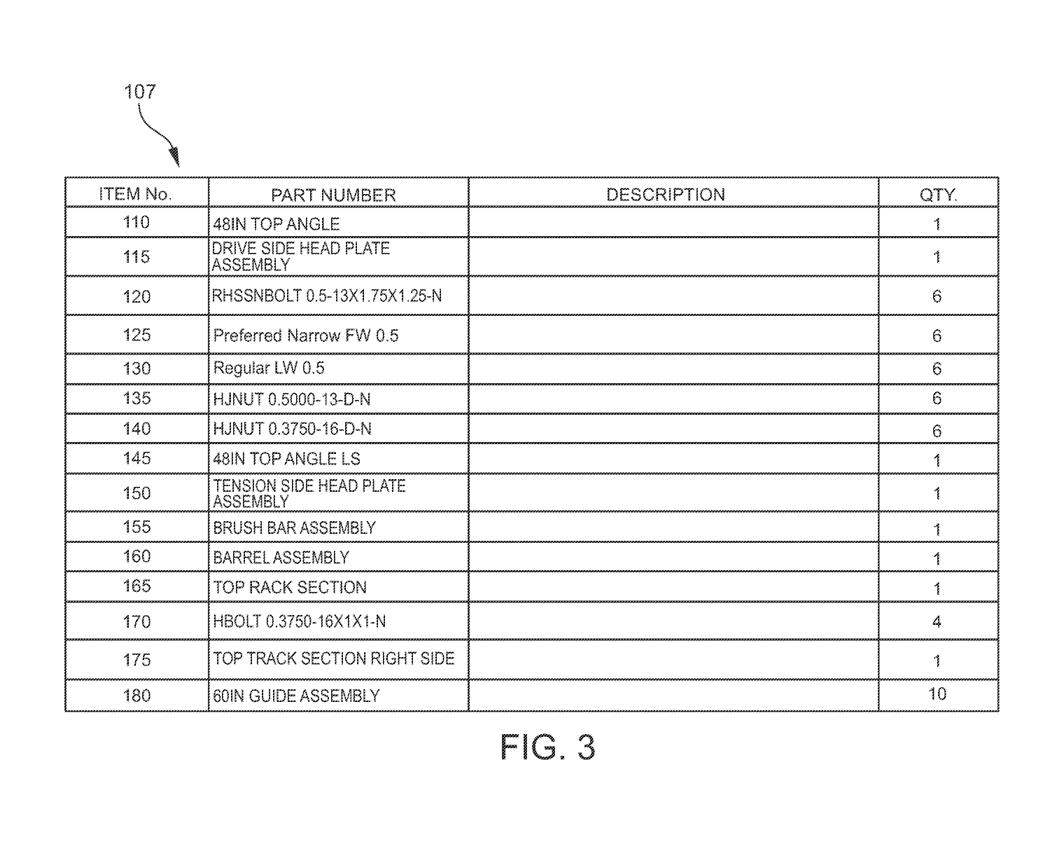

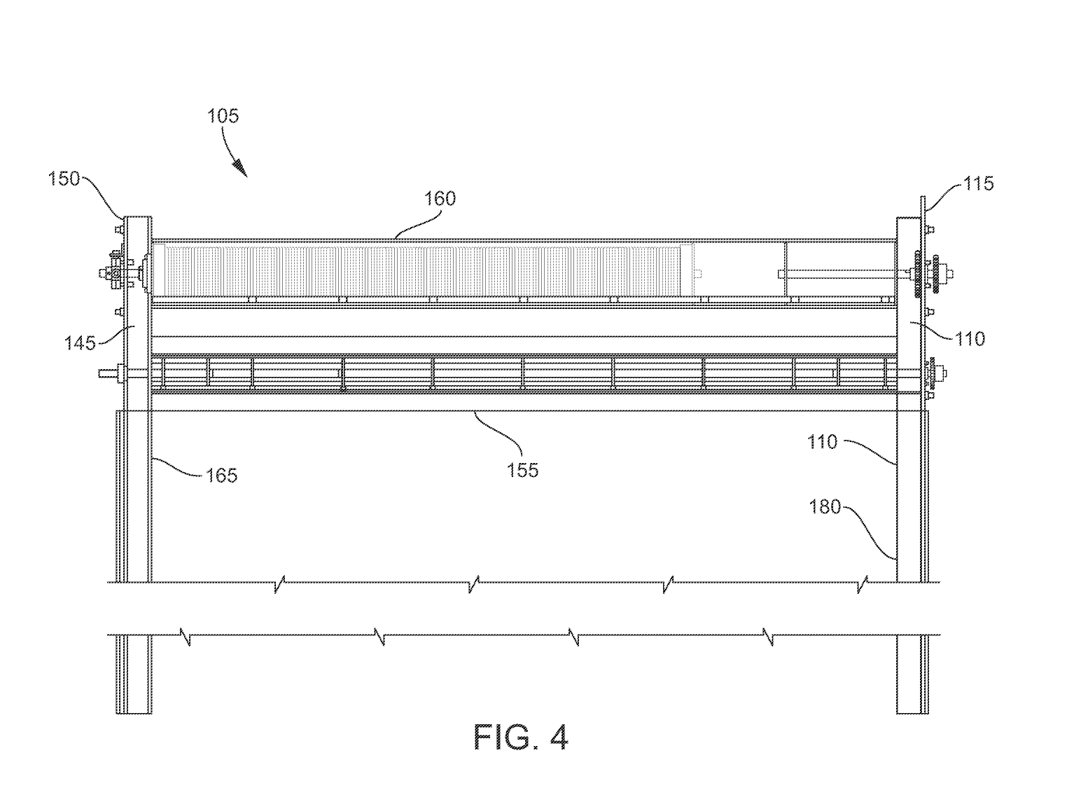

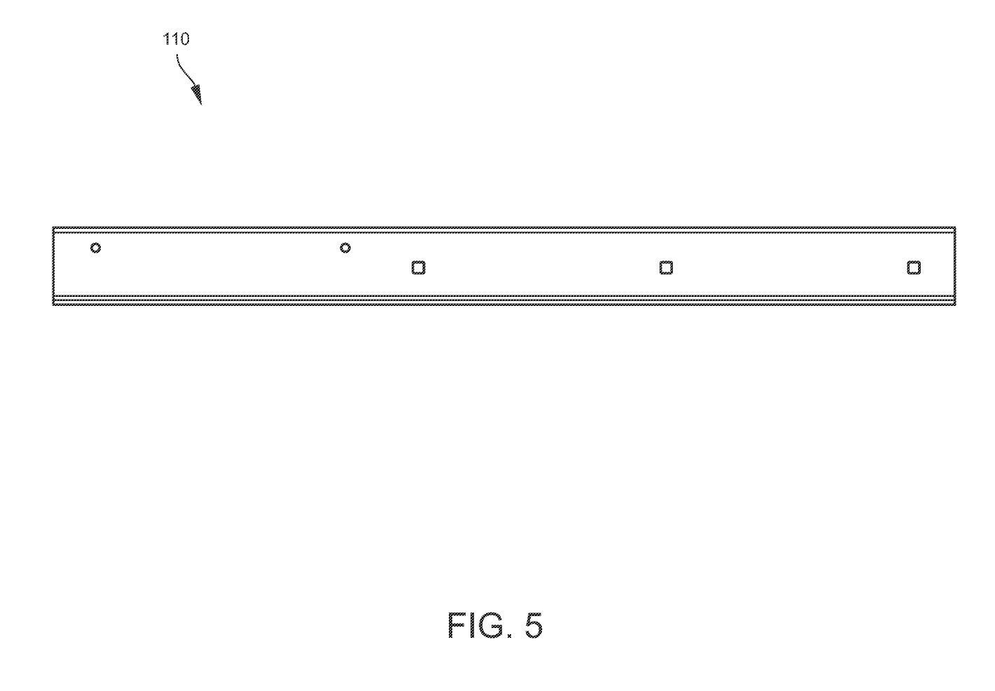

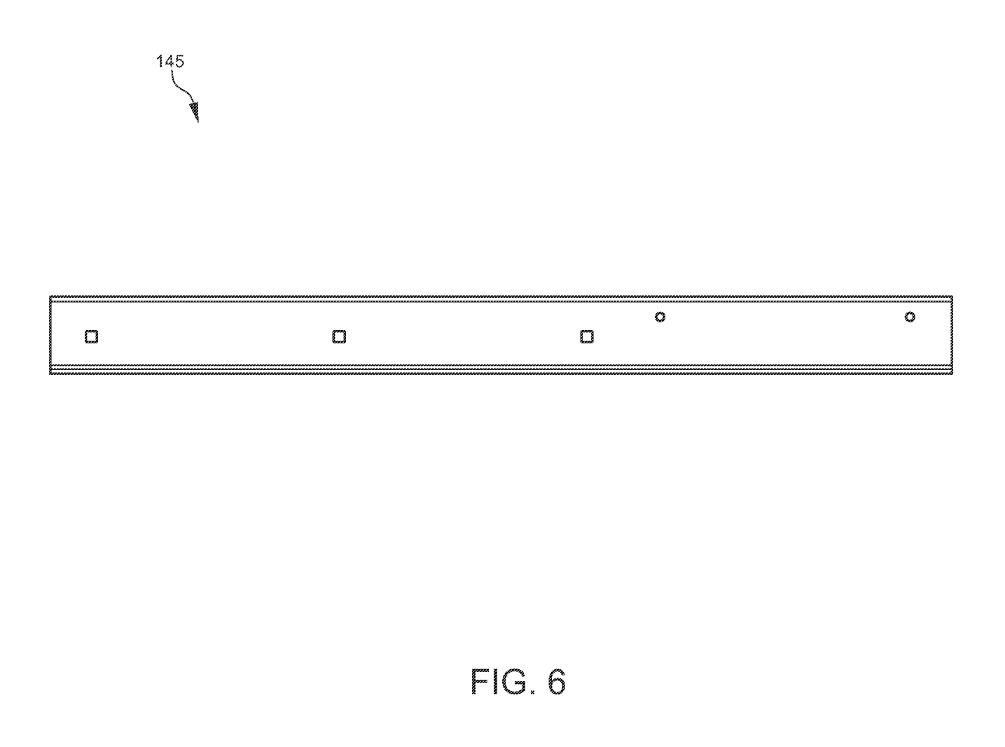

FIG. 2 shows a front view of an example of drive or main assembly 105. FIG. 3 shows a Table 107 that lists certain components of the drive or main assembly 105 shown in FIG. 2. For example, drive or main assembly 105 may include a right side 48-inch top angle 110 (shown in FIG. 5), a drive side head plate assembly 115, a bolt 120, a narrow FW 125, a regular LW 130, a nut 135, a nut 140, a left side 48-inch top angle 145 (shown in FIG. 6), a tension side head plate assembly 150, a brush bar assembly 155, a barrel assembly 160, a top track section 165, an H-bolt 170, a top track section right side 175, and a 60-inch guide assembly 180. FIG. 4 shows more details of drive or main assembly 105 and shows some of the components listed in Table 107.

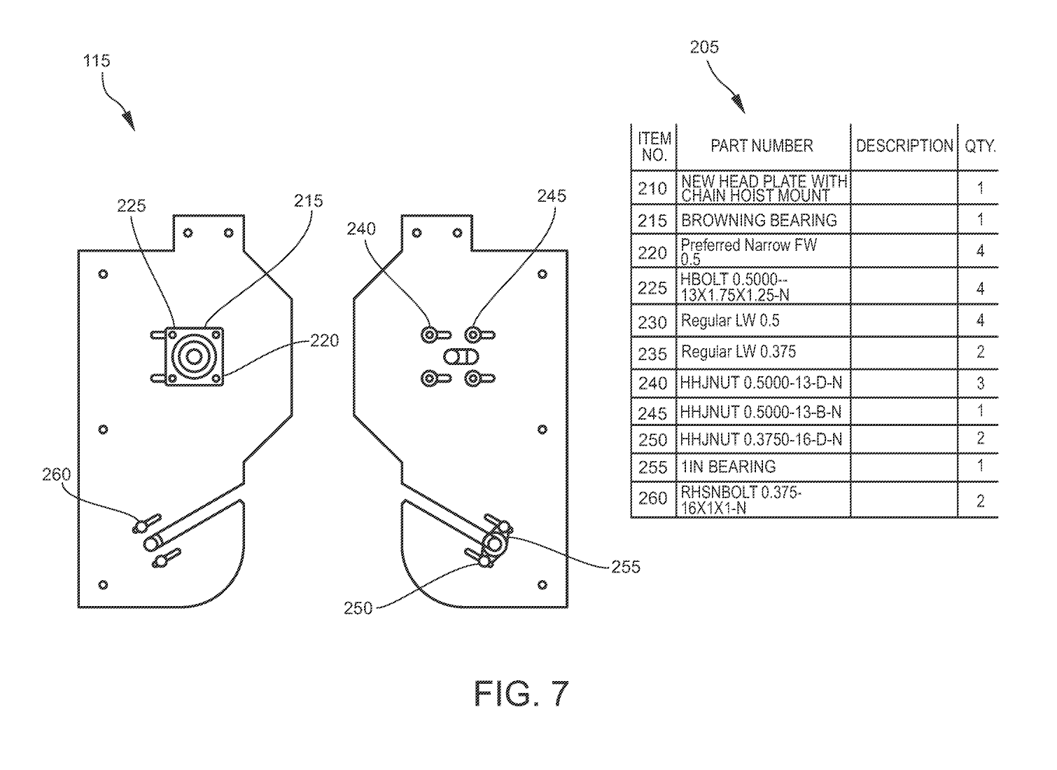

Referring now to FIG. 7 through FIG. 12, various views of a head plate bracket assembly of the presently disclosed freezer blast cell fabric roll up door 100 are shown. Namely, the head plate bracket assembly comprises drive side head plate assembly 115 and tension side head plate assembly 150 shown in FIG. 2, FIG. 3, and FIG. 4.

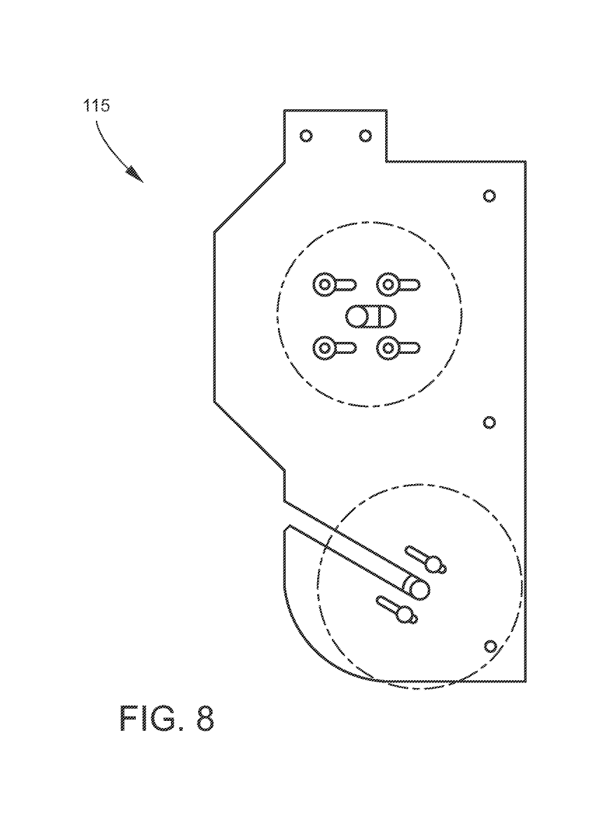

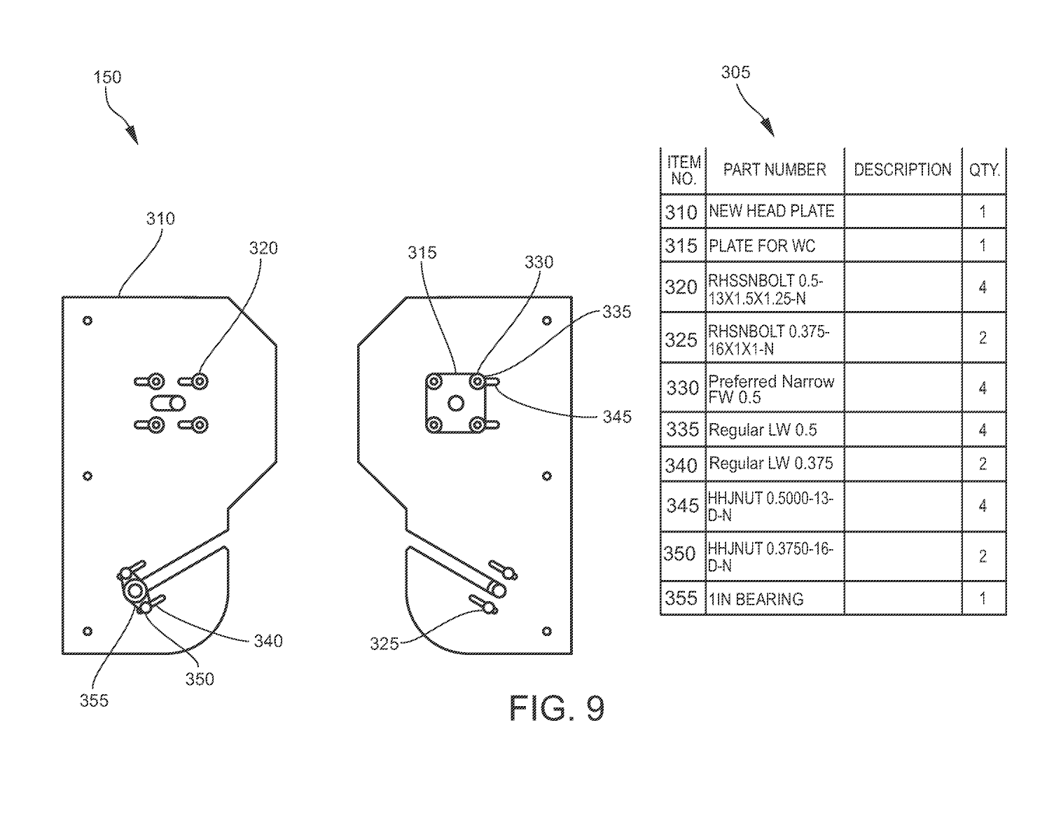

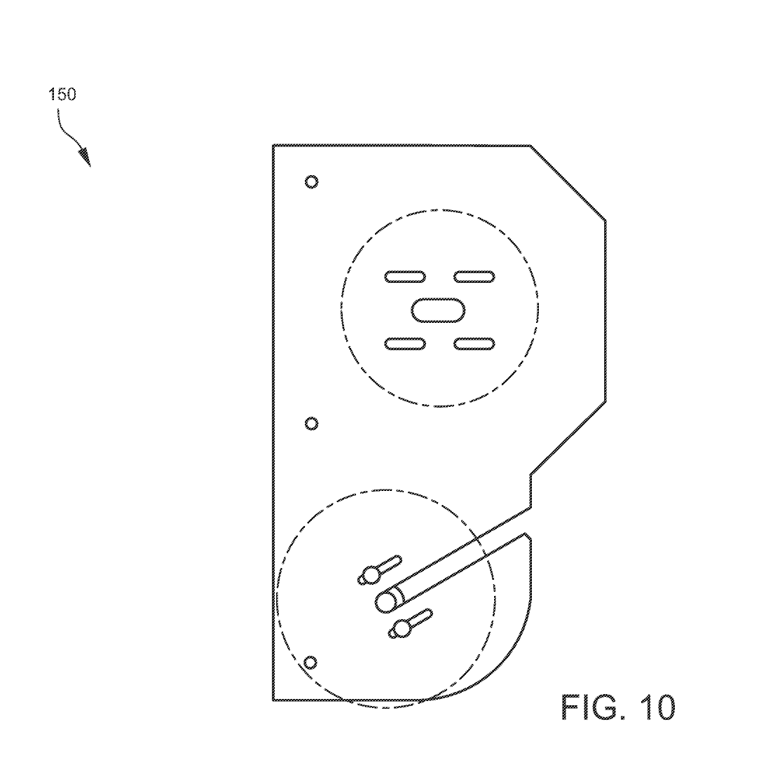

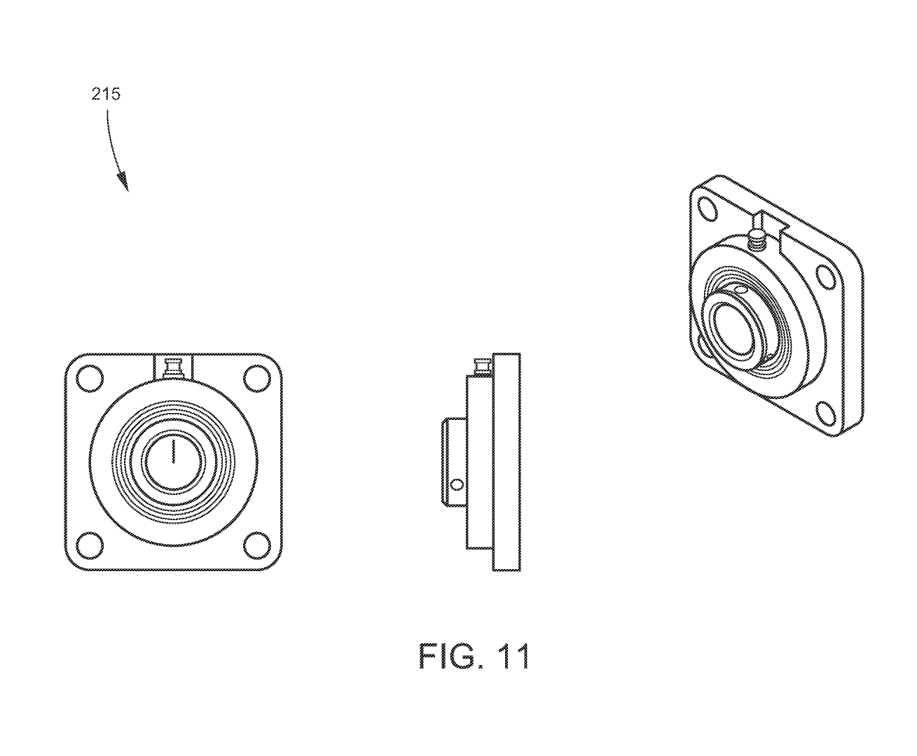

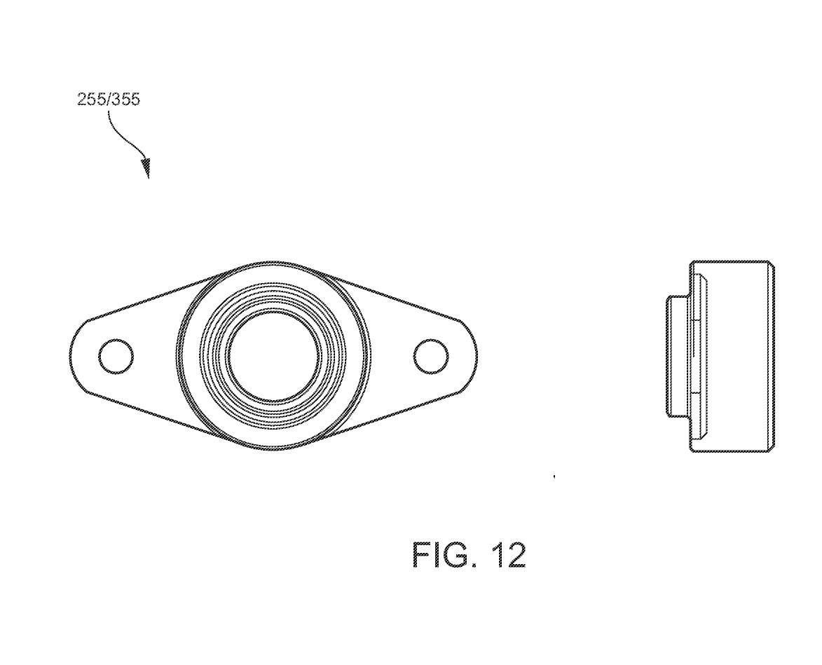

FIG. 7 and FIG. 8 show more details of drive side head plate assembly 115. Table 205 on FIG. 7 lists the components of drive side head plate assembly 115. FIG. 9 and FIG. 10 show more details of tension side head plate assembly 150. Table 305 on FIG. 9 lists the components of tension side head plate assembly 150. Further, FIG. 11 shows more details of a browning bearing 215 of drive side head plate assembly 115. FIG. 12 shows more details of a 1-inch bearing 255 of drive side head plate assembly 115 and a 1-inch bearing 355 of tension side head plate assembly 150.

Generally, the head plate bracket assembly is constructed from a steel plate and a steel angle. The head plate brackets are mounted to the top of the door guides. These brackets house the completed barrel, curtain, and drive assemblies. These brackets are made to a unique shape allowing for the barrel assembly to have some forward and backward adjustment to optimize clearance for the curtain as it is rolled around the barrel while being put in the up position. It also provides the slotted adjustments for the brush bar and bearing assembly.

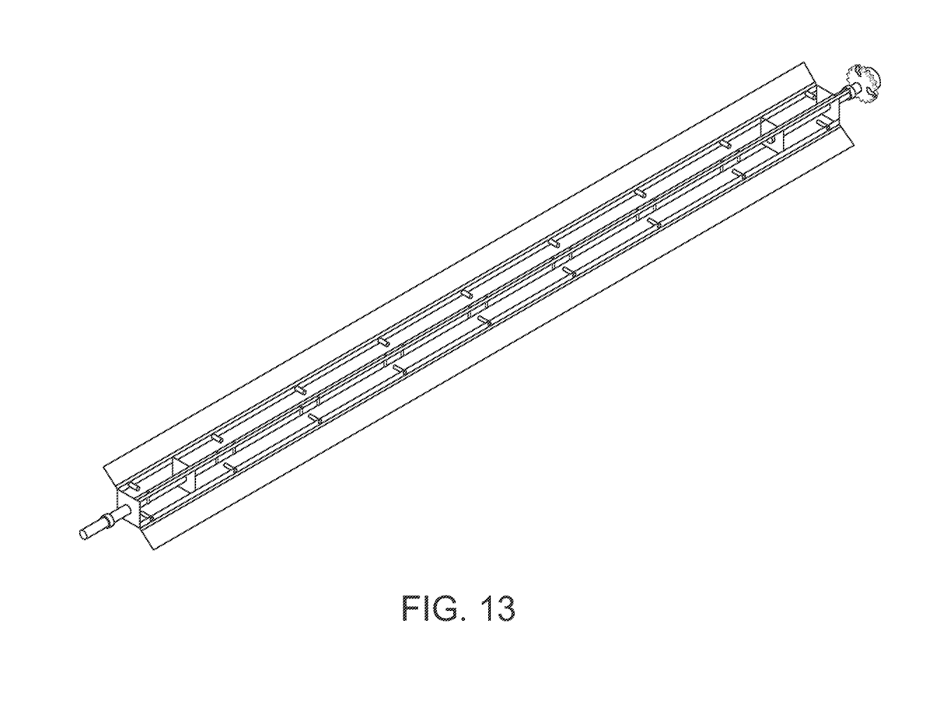

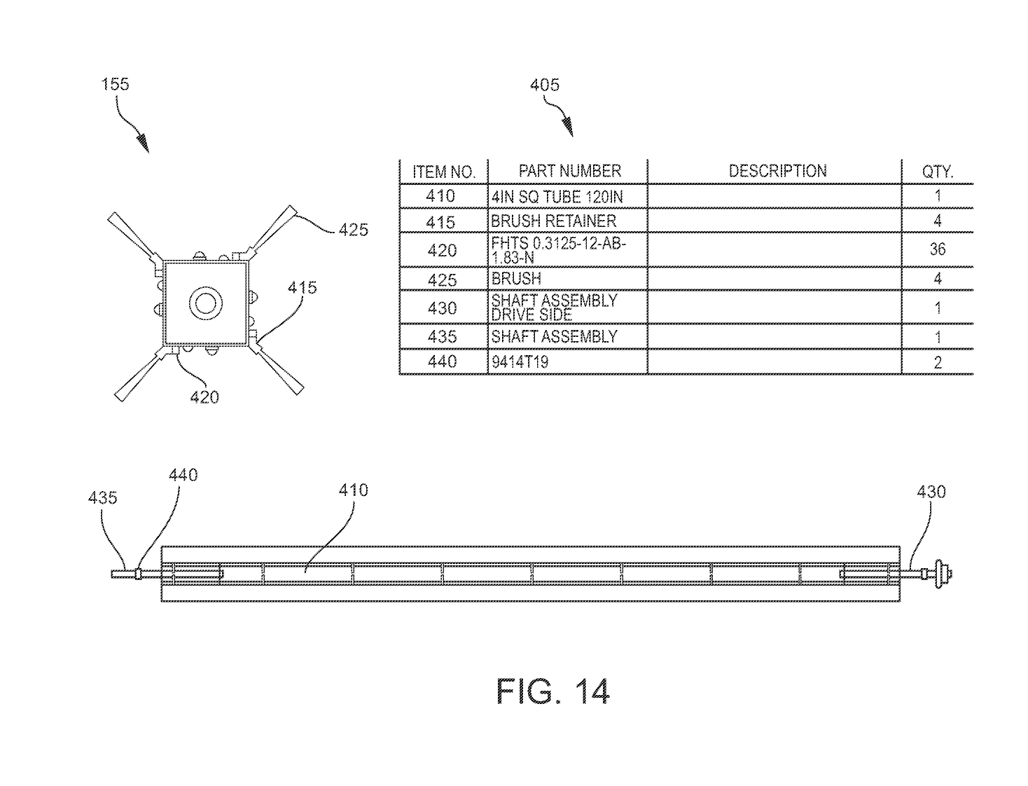

Referring now to FIG. 13 through FIG. 18, various views of brush bar assembly 155 of the presently disclosed freezer blast cell fabric roll up door 100 are shown. Table 405 on FIG. 14 lists the components of brush bar assembly 155.

Generally, brush bar assembly 155 is constructed from the following items: steel tube, steel shaft, brush seal, brush seal retainer, and fastening hardware. These items are assembled in a unique manner in which it becomes the sweep. The brush seal retainer is mounted at predetermined locations around the tube. The brush seal is then slid into the retainer creating a multisided sweep equal to the width of the curtain. This assembly has a steel shaft in each end. These shafts go through bearings that have adjustable slots located it the head plate brackets. There is a gear placed on the drive side of this shaft. This gear is attached to another gear on the drive side of the barrel assembly. These are geared in a manner in which they have a different gear ratio than the drive gear on the curtain. This allows the brush bar to spin at a higher RPM than the curtain is traveling. This is mounted so the brush is touching the curtain at all times, effectively creating the sweep that removes the excess frost that often occurs on the curtain in the harsh environment of the blast freezer. The brush bar operates every time the door is raised or lowered. Removing excess frost on each cycle prevents ice from accumulating on the door to the point where the added ice weight can affect the operation of the door. The brush bar also eliminates the need for personnel to periodically go into the freezer and manually remove this frost accumulation.

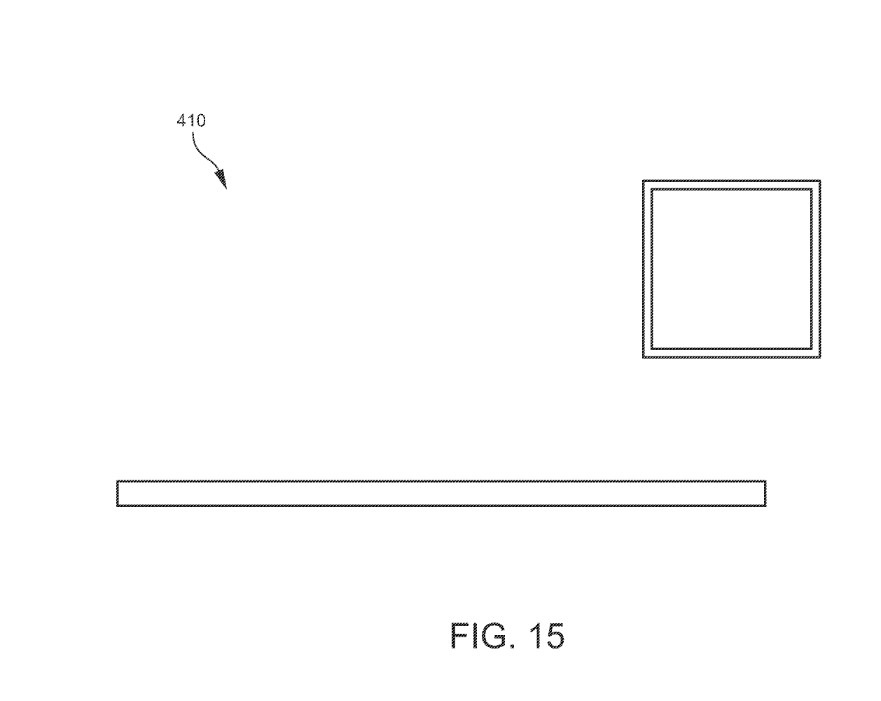

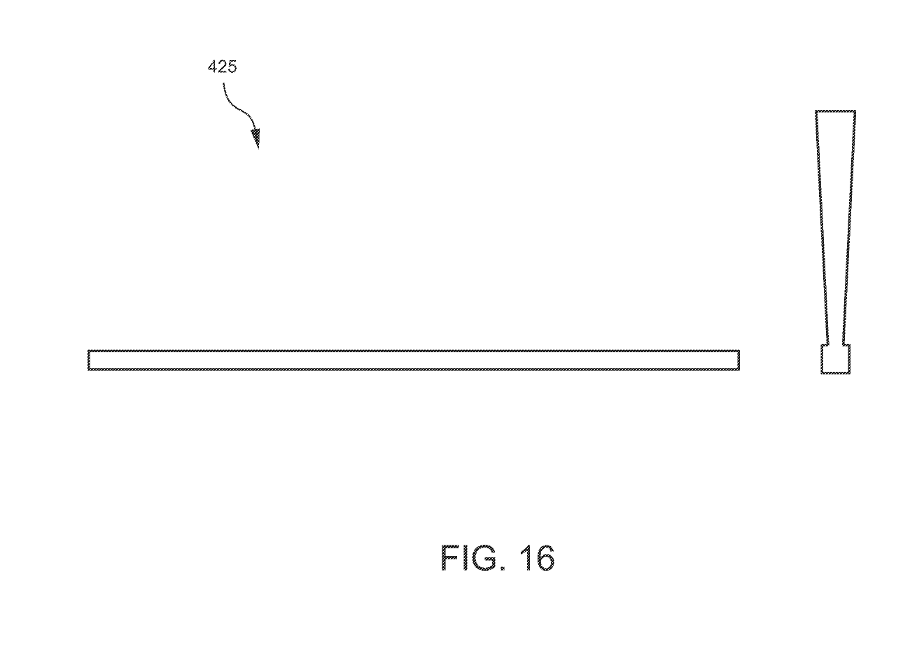

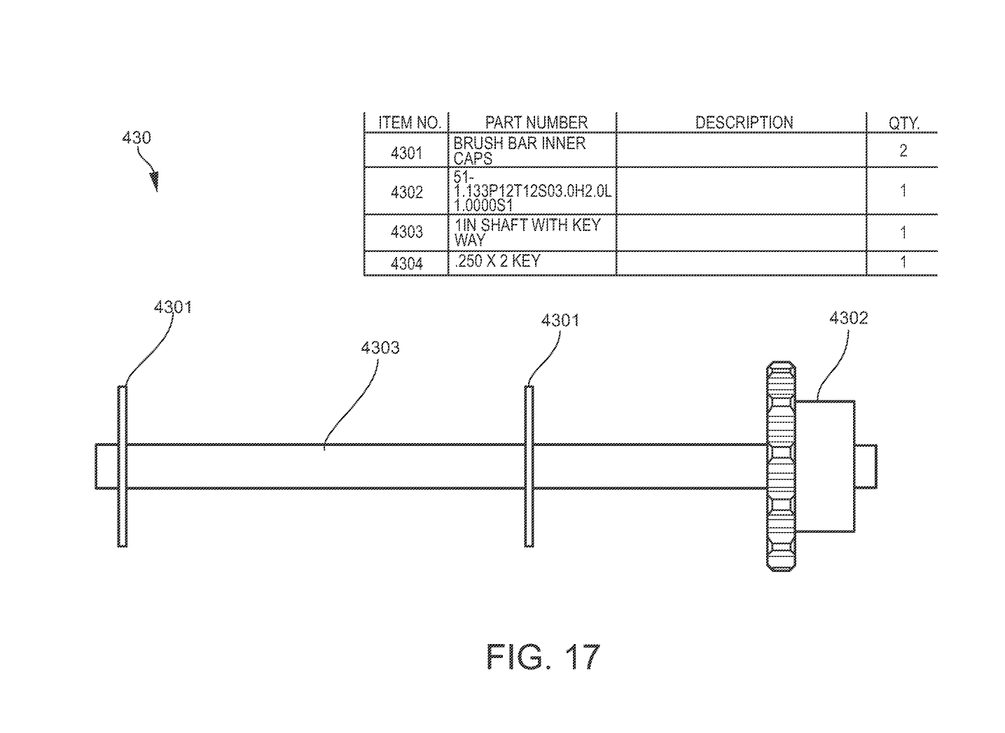

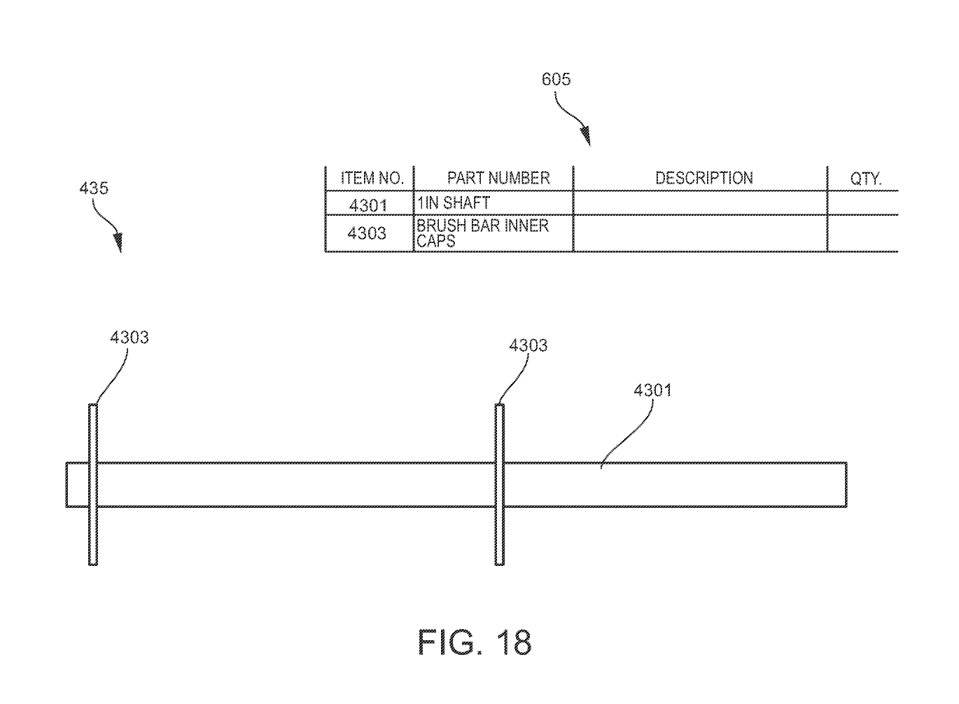

FIG. 15 through FIG. 18 show examples of certain components of brush bar assembly 155. For example, FIG. 15 shows a 4-inch square tube 410 of brush bar assembly 155. FIG. 16 shows a brush 425 of brush bar assembly 155. FIG. 17 shows a drive side shaft assembly 430 of brush bar assembly 155 and a Table 505 listing the components of drive side shaft assembly 430. FIG. 18 shows a shaft assembly 435 of brush bar assembly 155 and a Table 605 listing the components of shaft assembly 435.

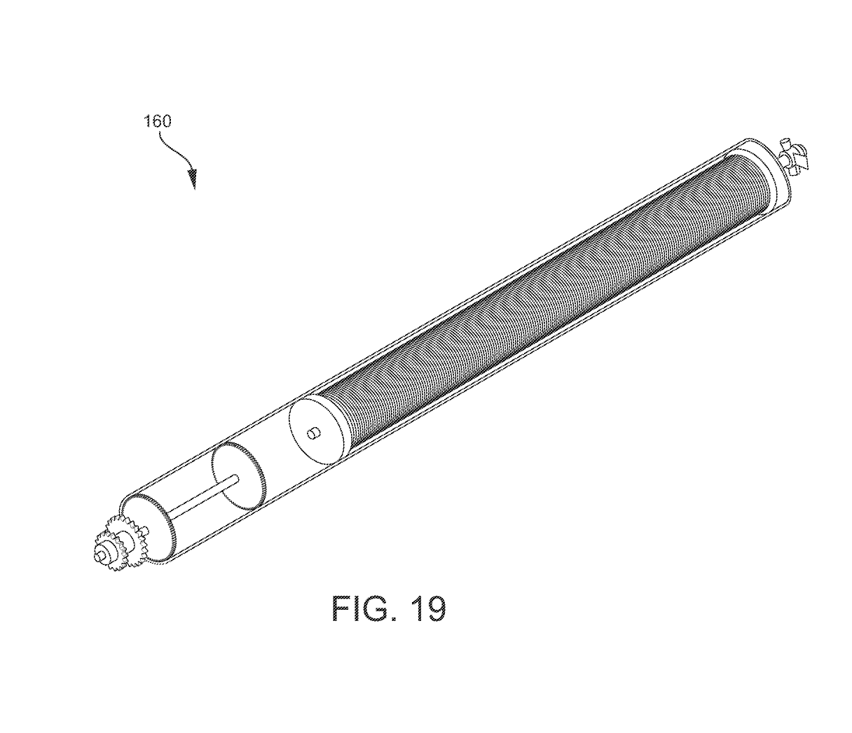

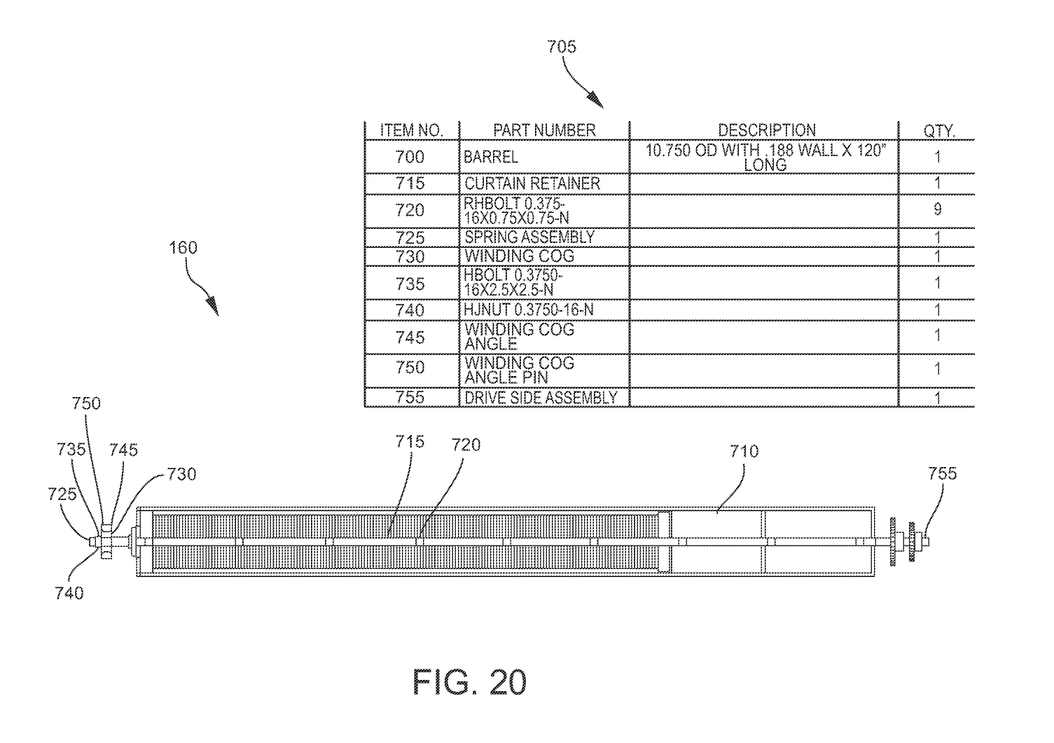

Referring now to FIG. 19 through FIG. 26, various views of barrel assembly 160 of the presently disclosed freezer blast cell fabric roll up door 100 are shown. Table 705 on FIG. 20 lists the components of barrel assembly 160.

Generally, barrel assembly 160 serves multiple functions for the roll up door. These parts are assembled in a manner in which it houses the torsion spring to act as the counter balance for the door curtain. The curtain is attached to the barrel providing a place for the curtain to wrap around while the door is being opened. It also allows it to feed uniformly into the guides as it is being closed. The barrel assembly is constructed from the following items: 10″ schedule 40 steel pipe, torsion spring, torsion spring attachment plates, steel shaft for torsion spring attachment, bearing, curtain retainer, winding cog for adding tension to torsion spring, drive side shaft, drive side shaft collars, and hardware.

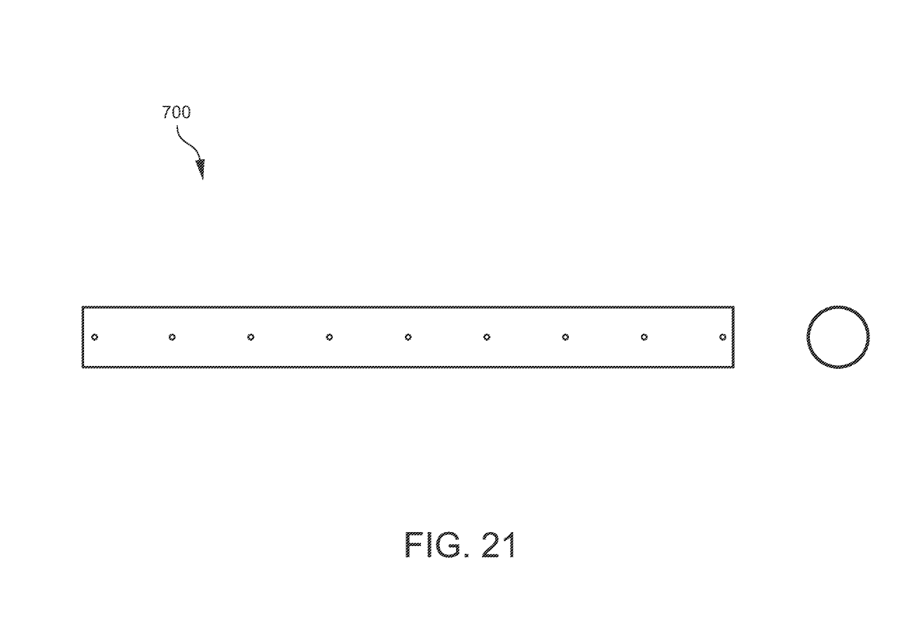

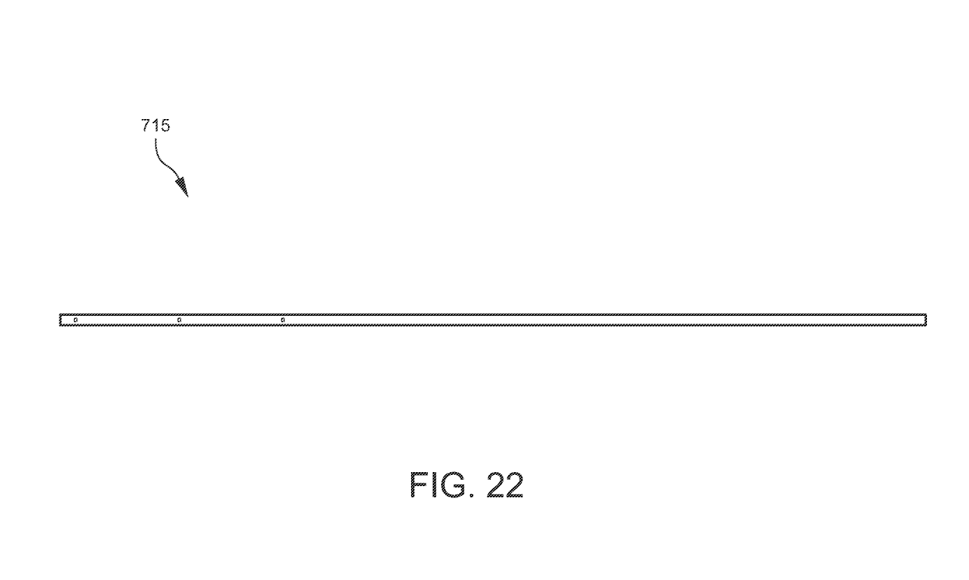

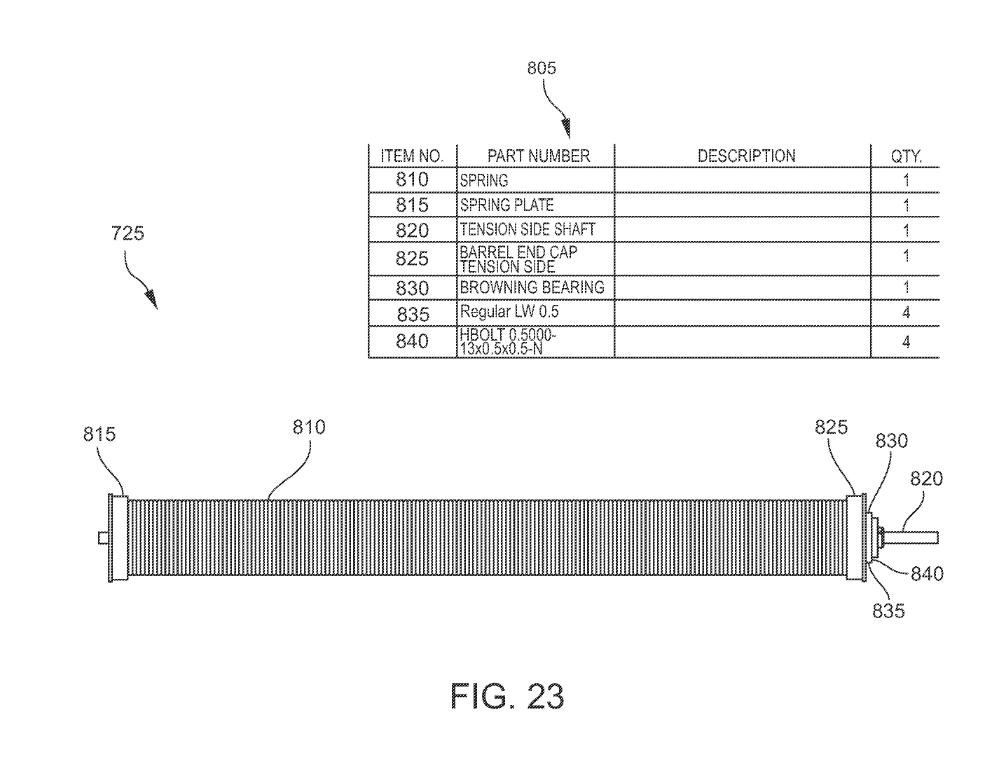

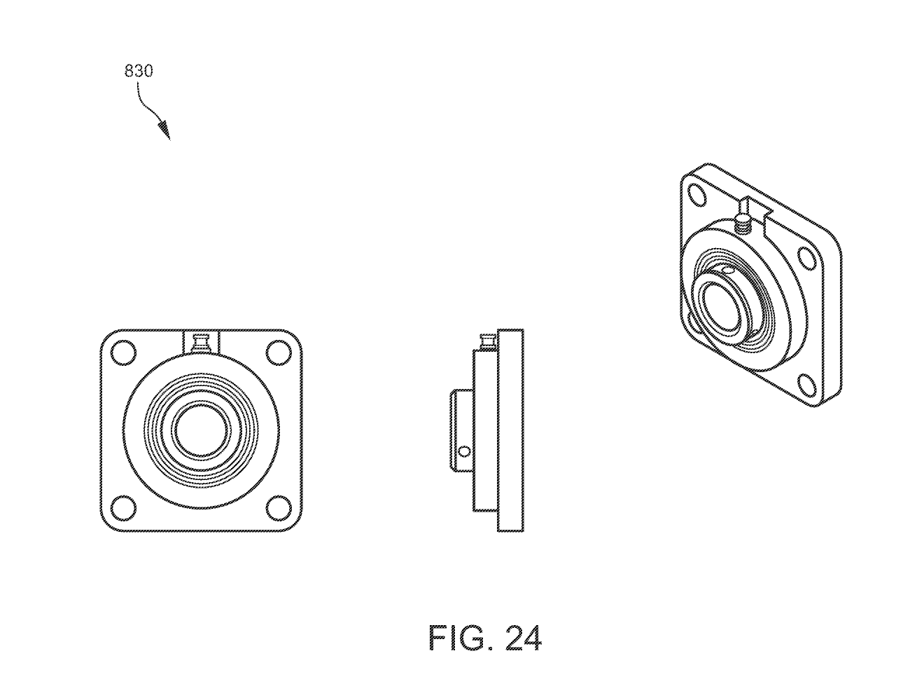

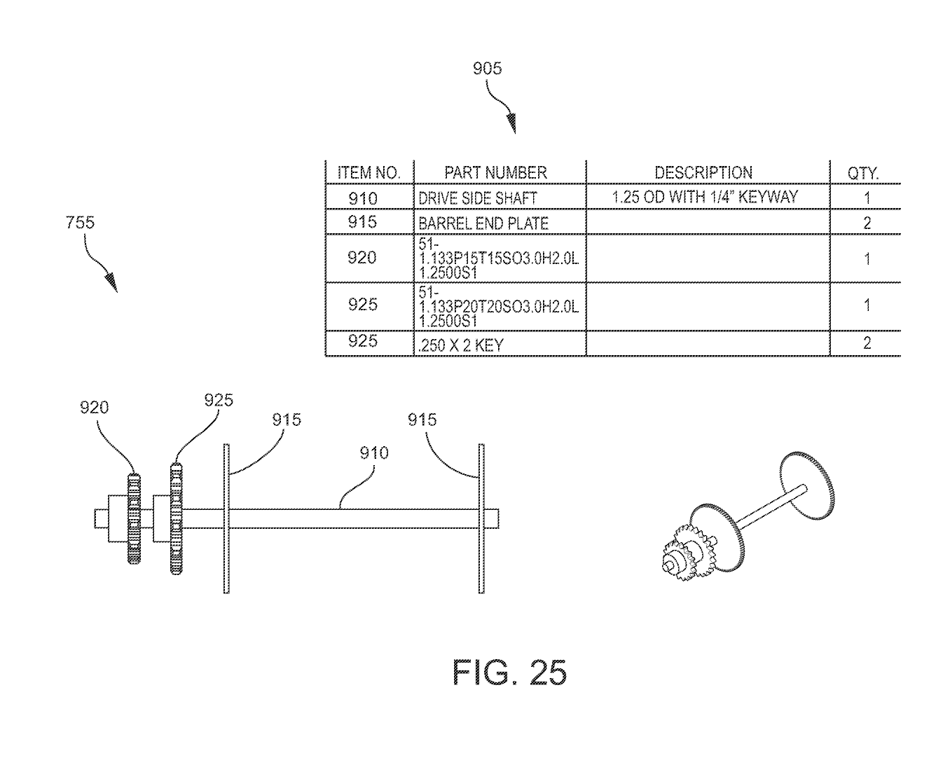

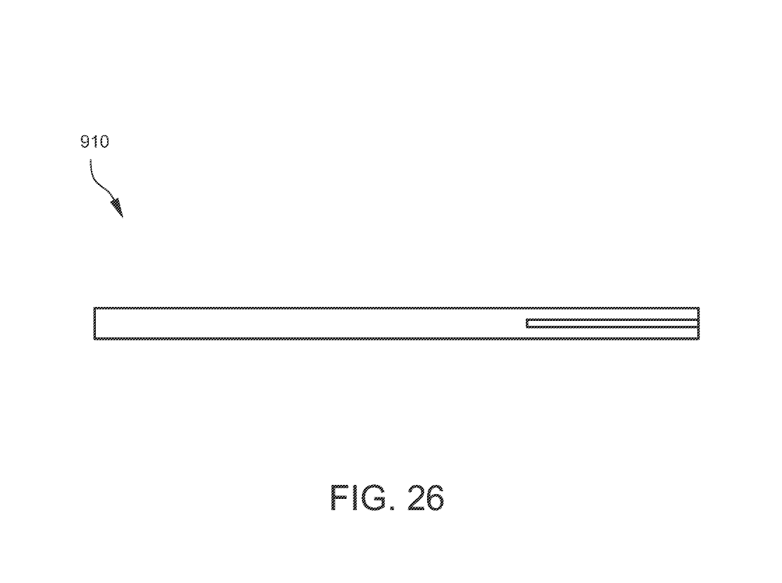

FIG. 21 through FIG. 26 show examples of certain components of barrel assembly 160. For example, FIG. 21 shows a barrel 700 of barrel assembly 160. FIG. 22 shows a curtain retainer 715 of barrel assembly 160. FIG. 23 shows a spring assembly 725 of barrel assembly 160 and a Table 805 listing the components of spring assembly 725. FIG. 24 shows a browning bearing 830 of spring assembly 725 of barrel assembly 160. FIG. 25 shows a drive side assembly 755 of barrel assembly 160 and a Table 905 listing the components of drive side assembly 755. FIG. 26 shows a drive side shaft 910 of drive side assembly 755 of barrel assembly 160.

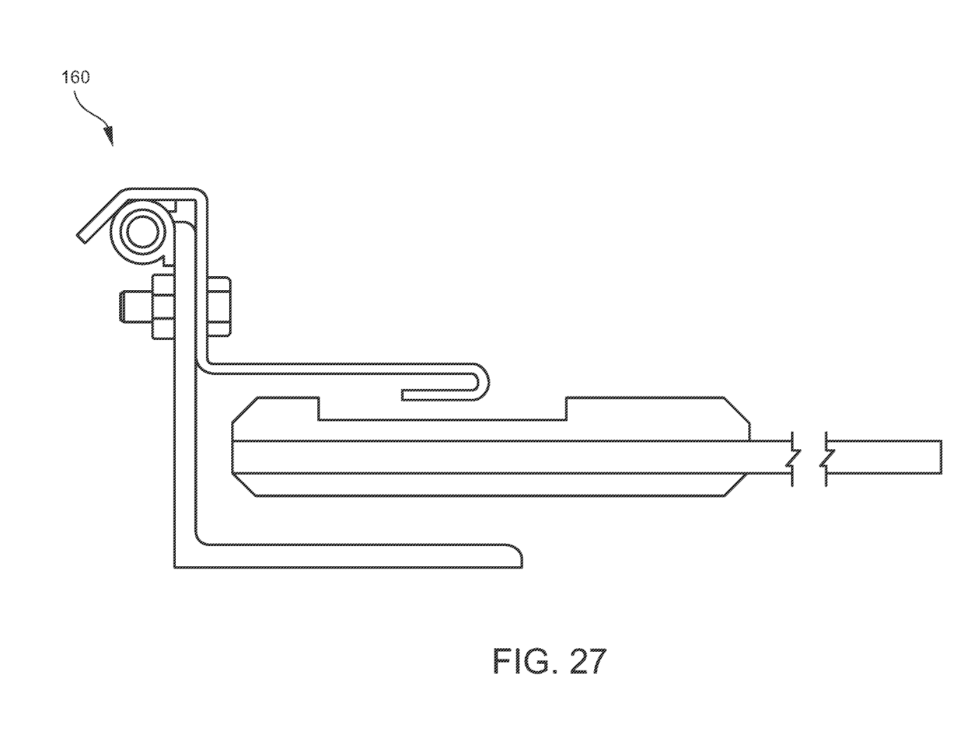

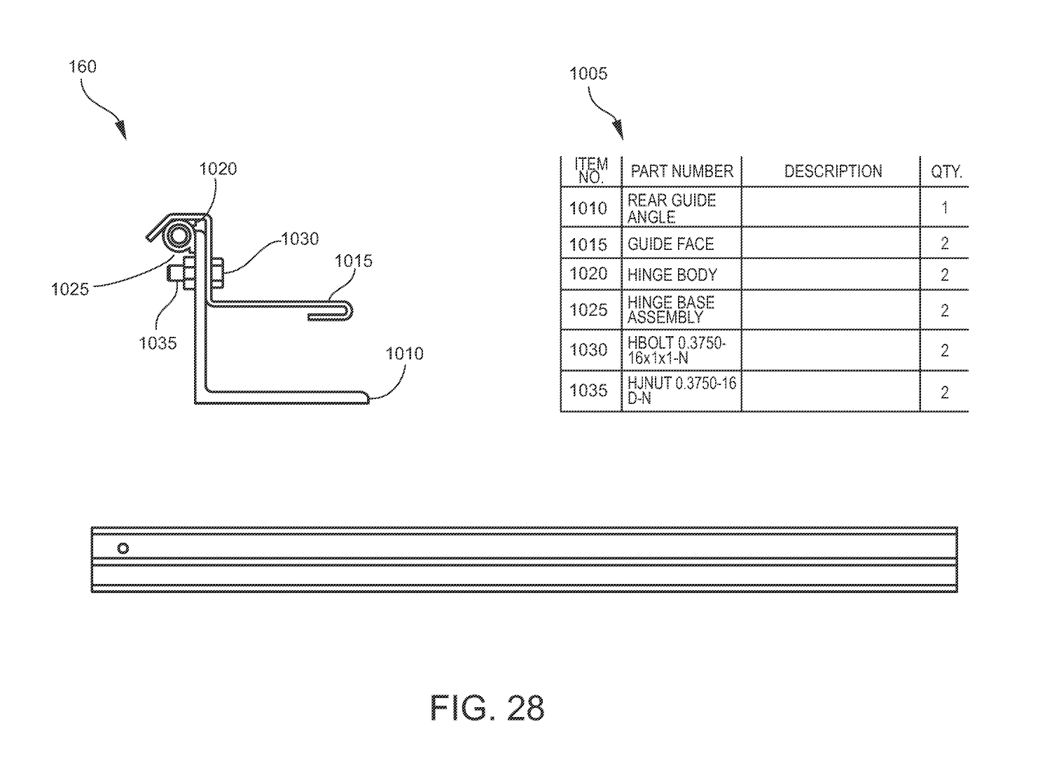

Referring now to FIG. 27 through FIG. 32, various views of 60-inch guide assembly 180 of the presently disclosed freezer blast cell fabric roll up door 100 are shown. Table 1005 on FIG. 28 lists the components of 60-inch guide assembly 180.

Generally, 60-inch guide assembly 180 is constructed from the following items: structural steel angle, computer numerically controlled (CNC) formed steel sections for guide face, bottom bar lock down feature, steel barrel hinges, assembly hardware. The guide assembly is the foundation for this door. All brackets and components are bolted to these guides. These guides consist of structural angles placed on each side of the opening at a predetermined distance running parallel with one another. The head plates that house the rest of the door are then bolted to these guides. The structural wall angle has separable barrel hinges welded in predetermined locations to accept the CNC formed steel guide face. These are formed in five foot sections that are hinged onto the structural wall angles. This allows for quick easy access to any point on the curtain if it were to require maintenance. These sections are kept in the closed position with two bolts. One near the top of each section and one near the bottom of each section. These sections are hinged in a manner that allows them to be pivoted out of the way or lifted entirely off the barrel hinge.

The CNC formed guide face sections are what hold the curtain in the opening while the door is in the closed position. These are formed pieces that incorporate the locking edge that works with the wind locks located on the major cross members of the curtain. This formed edge on the steel guide face is what the wind lock engages when force is applied.

Additionally, a unique hold down feature in the bottom of the guides prevents the bottom bar from being pulled up during any significant amount of wind load. The hold down feature includes half-round pieces of ultrahigh molecular weight (UHMW) plastic bolted at a predetermined location near the bottom of each guide assembly. This unique design allows the curtain to pass and raise above it automatically when there is no wind load on the curtain (i.e. while the curtain is in the relaxed position with the blast cell fans turned off). While the door is in the closed position and force is applied from either side of the opening it forces the bottom bar assembly to lock underneath the half-round UHMW preventing it from lifting the bottom bar to an unacceptable height. Without the hold down feature, the curtain acts as a wind sail undesirably lifting the bottom bar off the ground.

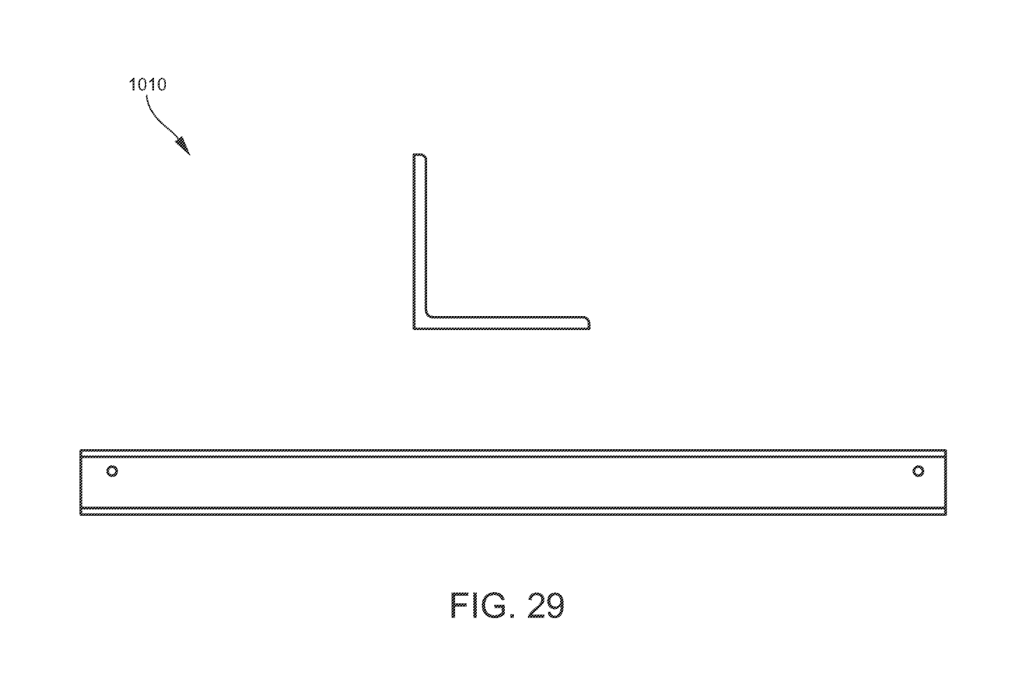

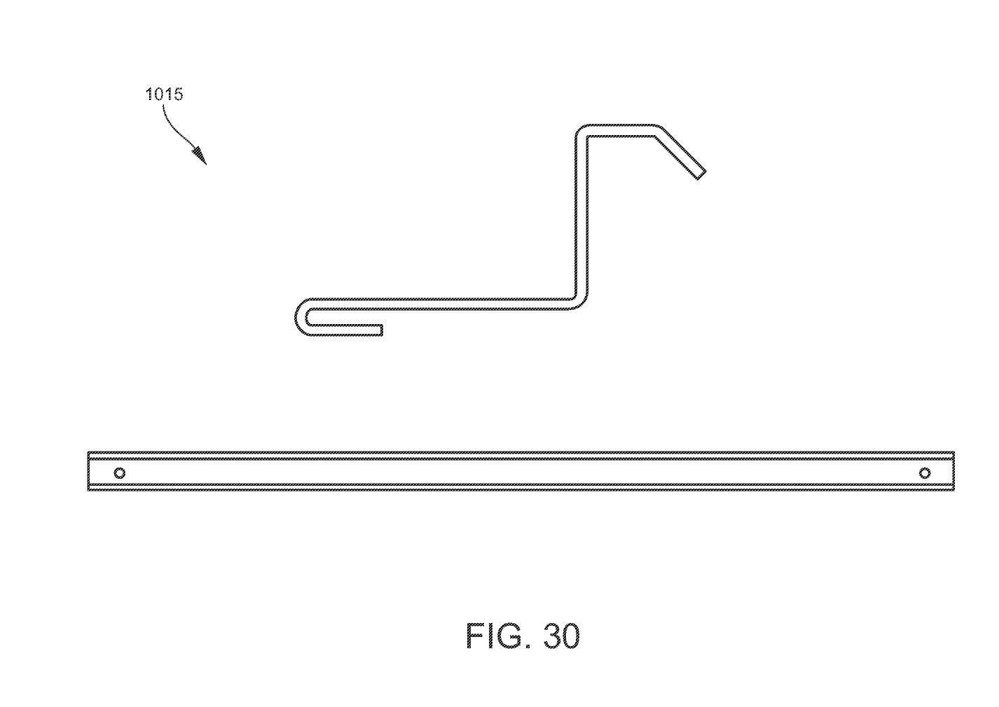

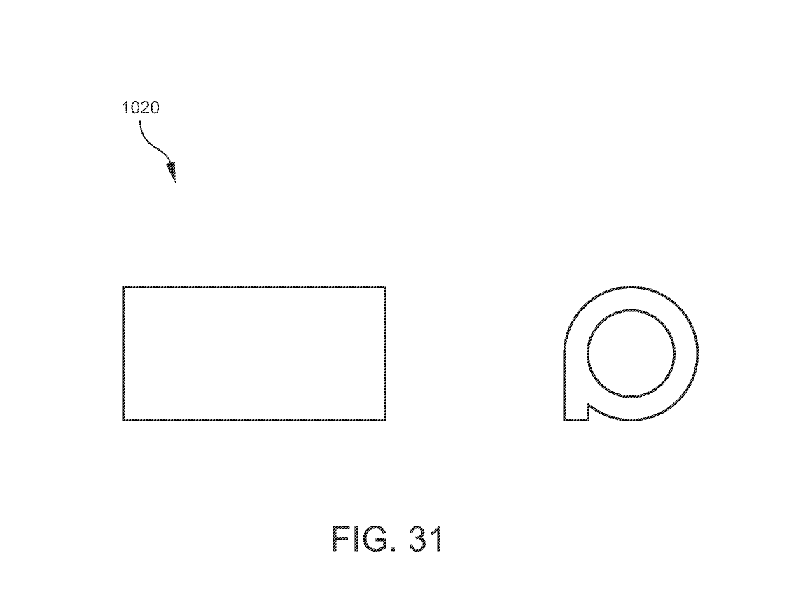

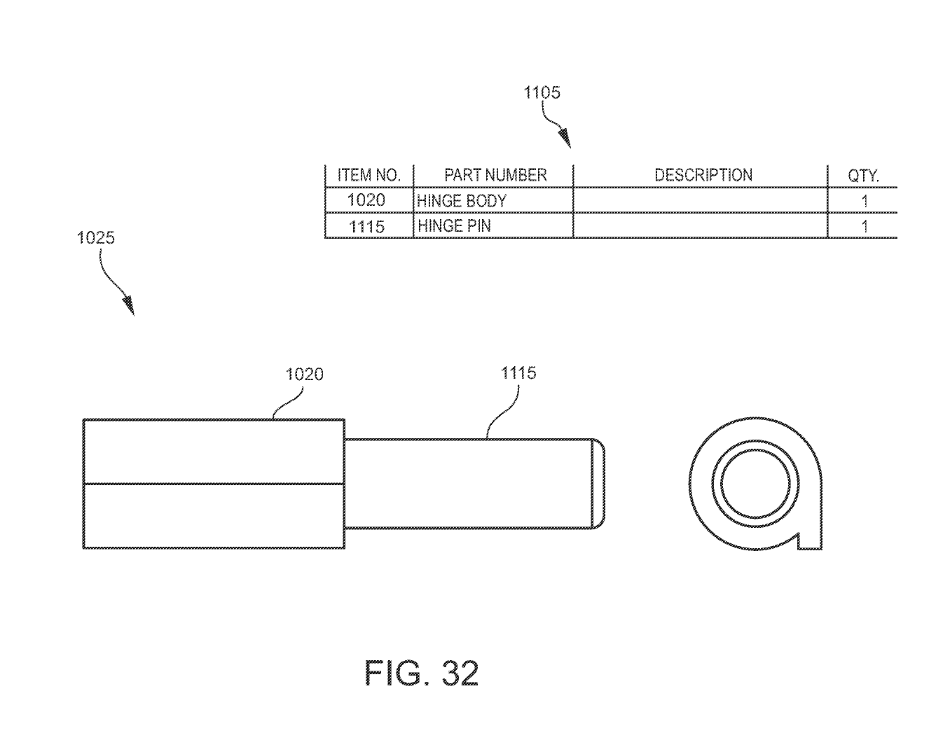

FIG. 29 through FIG. 32 show examples of certain components of 60-inch guide assembly 180. For example, FIG. 29 shows a rear guide angle 1010 of 60-inch guide assembly 180. FIG. 30 shows a guide face 1015 of 60-inch guide assembly 180. FIG. 31 shows a hinge body 1020 of 60-inch guide assembly 180. FIG. 32 shows a hinge base assembly 1025 of 60-inch guide assembly 180 and a Table 1105 listing the components of hinge base assembly 1025.

The curtain assembly of the presently disclosed freezer blast cell fabric roll up door 100 is constructed from the following items: fabric meeting the strength and freeze requirements for use in a blast freezer, aluminum cross members (major stiffeners), fiberglass cross members (minor stiffeners), wind lock tabs, wear tabs, bottom bar, and assembly hardware. The curtain creates the actual barrier between the freezer blast cell and the freezer environment they are generally housed in. The curtain attaches to the barrel and is then able to be raised and lowered into the opening creating the barrier.

The curtain is constructed from suitable fabrics meeting the requirements to withstand the negative temperature and retain the flexibility characteristics and strength qualities required of flexible blast freezer doors. The curtain includes horizontal pockets 190 at predetermined distances that span the width of the curtain (see FIGS. 1, 34 and 35). These horizontal pockets 190 allow for the major and minor stiffeners to be placed across the curtain. The major stiffeners then receive the wind locks and wear tabs which are through bolted through each end of the major stiffeners opposing each other. The wind locks and wear tabs ride partially in the guide and partially out of the guide. This helps combat any wear points on the curtain as it travels open and closed.

The front tab serving as the wind lock is machined in a unique manner in which it is able to lock onto the inside edge of the formed locking section of the guide. This wind lock allows the curtain to have a certain amount of flexibility in either direction depending on positive or negative air flow being produced by the freezing process. Once the curtain flexes to a certain point, the wind locks engage on the locking edge formed inside the guide preventing it from coming out any further. This prevents the curtain assembly from being forced completely out of the guides due to the extremely high wind loads generated during the blast cycle. Then, once the blast cycle is complete, the curtain may relax back into the guide position and further allowing the door to be put in the open position.

Additionally, a bottom bar 185 is placed on the lower edge of the curtain to add rigidity and weight to the leading edge of the fabric (see FIGS. 2, 4, 34 and 35). The weight of the bottom bar 185 assists in balancing the curtain with the torsion spring. The tension created in the fabric by the weight of the bottom bar 185 aids in the travel of the door in each direction (i.e. opening direction and closing direction). The bottom bar 185 usually consists of two opposing angle bars bolted through the fabric forming a flat surface across the bottom of the curtain to close against the floor. The vertical legs of the bottom bar 185 that are through bolted through the fabric aid in the unique lock down feature placed in the bottom of the guide assembly.

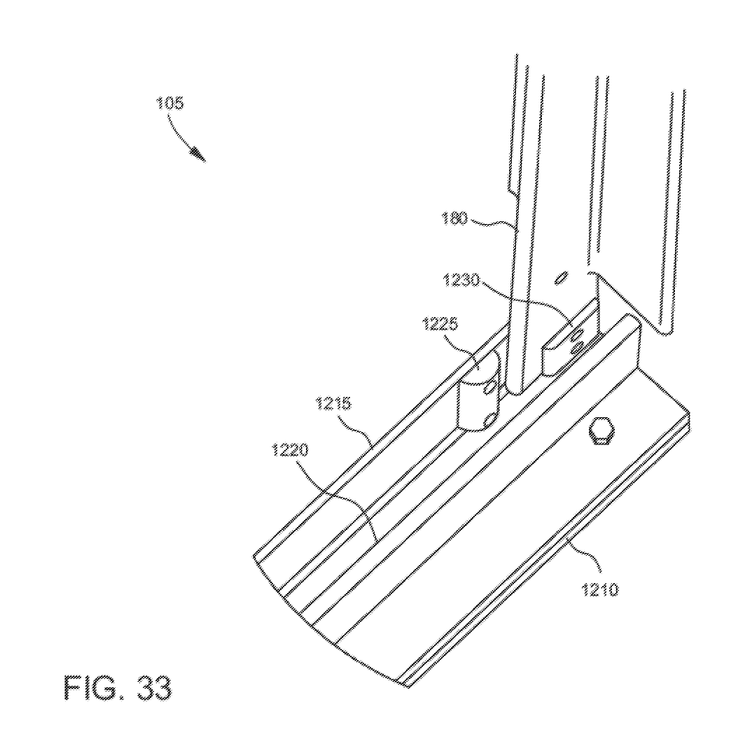

FIG. 33 shows a perspective view of one corner of the lower portion of the frame of the drive assembly 105. For example, FIG. 33 shows the lower portion of the 60-inch guide assembly 180 abutting at about a 90 degree angle with a base plate 1210, as shown. A first guide rail 1215 and a second guide rail 1220 are arranged on edge along the length of the base plate 1210, as shown. A half-round catch block 1225 is provided on the face of the first guide rail 1215 that is facing the second guide rail 1220 and near the 60-inch guide assembly 180. A wear tab 1230 is provided on the face of the 60-inch guide assembly 180 and abutting the base plate 1210. In one example, the half-round catch block 1225 is about 3.5 inches long and about 1.25 inches wide. In one example, the wear tab 1230 is about 2 inches square and is about 0.25 inches thick. Let it be noted that the other corner of the lower portion of the frame of the drive assembly 105, which is not shown, likewise includes a half-round catch block 1225 and a wear tab 1230. Further, any number of the half-round catch blocks 1225 can be provided along the length of the first guide rail 1215. Additionally, in another example the half-round catch blocks 1225 can be provided on the second guide rail 1220 instead of the first guide rail 1215.

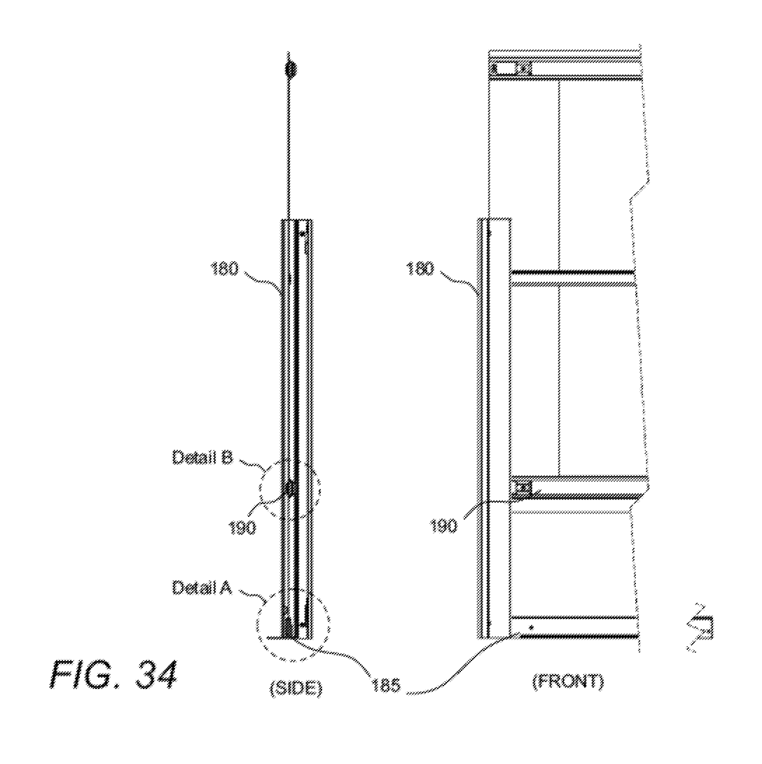

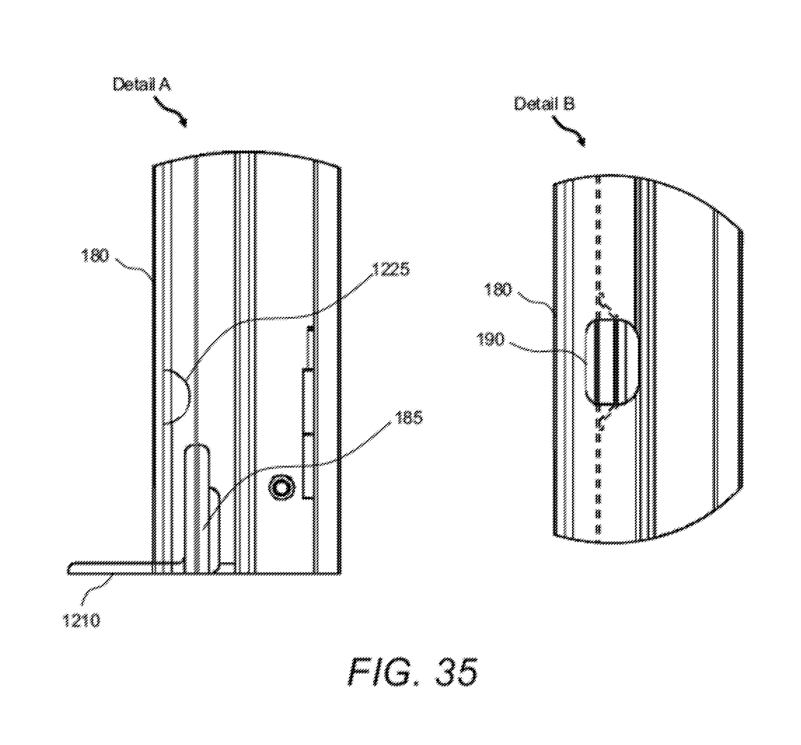

The half-round catch blocks 1225 and the wear tabs 1230 provide a stop mechanism for the curtain. Namely, the bottom bar 185 on the lower edge of the curtain falls in under the half-round catch blocks 1225 when the curtain is lowered (see FIGS. 34 and 35). The wind load causes the bottom bar 185 to go under the half-round catch blocks 1225, locking the curtain in the down position. The number and locations of the half-round catch blocks 1225 may depend on the wind direction. For example, while FIG. 33 shows the half-round catch blocks 1225 on the inner face of the first guide rail 1215, for opposite wind direction the half-round catch blocks 1225 can be placed on the second guide rail 1220.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A freezer blast cell fabric roll up door assembly comprising a drive assembly, a head plate bracket assembly, a brush bar assembly, a barrel assembly, a guide assembly; and a curtain assembly, wherein the guide assembly further comprises:
a. a formed edge that interlocks with wind locks on the curtain assembly when wind loads are applied; and
b. a hold down feature disposed at a bottom portion of the guide assembly that receives a bottom bar assembly disposed at a lower end of the curtain assembly, thereby preventing the door from rising off the ground when wind loads are applied.

2. The door assembly of claim 1, wherein the brush bar assembly comprises one or more brushes coupled to a bar, wherein the one or more brushes have a length substantially equal to the width of the curtain assembly, and further wherein when the door is opened or closed at a certain speed, the brush bar assembly rotates at a speed greater than the speed of the moving door, thereby brushing excess frost off the door as it opens or closes.

3. The door assembly of claim 1, wherein the curtain assembly further comprises horizontal pockets.

4. The door assembly of claim 3, wherein the curtain assembly further comprises stiffener bars in the horizontal pockets.

5. The door assembly of claim 4, wherein the barrel assembly further comprises a torsion spring coupled to the curtain assembly such that the torsion spring counter balances the curtain assembly, making the curtain assembly easier to raise and lower.

6. The door assembly of claim 1, wherein the hold down feature comprises:
a. a lower portion of the guide assembly abutting a base plate at an angle substantially equal to 90 degrees;
b. a first guide rail and a second guide rail arranged on edge along the length of the base plate;
c. two or more half-round catch blocks are provided on a face of the first guide rail or the second guide rail; and
d. two or more wear tabs provided on a face of the guide assembly, wherein the two or more wear tabs abut the base plate;
wherein the bottom bar assembly disposed at the lower end of the curtain falls in under the two or more half-round catch blocks when the curtain is lowered, and wherein a wind load causes the bottom bar assembly to go under the half-round catch blocks to lock the curtain in a down position.
